(19) United States
(12) Patent Application Publication
(10) Pub. No.: US 2006/0256662 A1
(43) Pub. Date: Nov. 16, 2006

(54) Picture frame with elasped time display

(76) Inventor: Charles L. Martin, Montrose, CA (US)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/129,326

(22) Filed: May 16, 2005

(51) Int. Cl. G04B 47/00

(52) U.S. Cl. 368/10

(57) ABSTRACT

A picture frame having an area for display of an image and an elapsed time display relating to the image for displaying time elapsed since an event related to the image. The frame may include indicia or a statement verbally expressing the relationship between the image and the time. The elapsed time is displayed in years, months, days and hours.

### FIELD OF THE INVENTION

This invention relates to a picture frame with an elapsed time display. More particularly, this invention relates to a picture frame for framing an image which relates to elapsed time shown in the elapsed time display.

### BACKGROUND OF THE INVENTION

Images of an event such as the birth of a baby, a relationship, acquiring a pet and any other memorable event are frequently stored in frames. The question frequently arises as to the duration of the subject of the image or the time elapsed with respect to the occurrence of an event. This question is almost always asked verbally whether orally or in writing. Currently, there is no way to look at an image and to immediately place that image in elapsed time. Not infrequently, a date accompanies an image, but that date does not immediately inform an observer of elapsed time with respect to that image. In view of these considerations, there is the need for a device which displays an image as well as elapsed time with respect to that image.

### SUMMARY OF THE INVENTION

A picture frame comprises a frame enclosing an area for displaying an image of the subject, the subject being related to a time at which an event occurred. A chronometer is integral with the frame and counts time forward from the occurrence of the event. Switching is disposed on the frame and connected to the chronometer for actuating the chronometer to count time from the occurrence of the event and an elapsed time display is positioned on the frame and connected to the chronometer for displaying accumulated time since the occurrence of the event in years, months and days.

In a further aspect of the picture frame the display further includes hours.

In still a further aspect of the picture frame, the display is circular and divided by four radial lines into four segments which display years, months, days and hours.

In still a further aspect of the picture frame, the frame includes indicia proximate the area for displaying the image relating the subject of the image to the elapsed time displayed.

In further arrangements of the picture frame, the subject is a person and the event is the person's birth or a memorable occasion relating to the subject or the subject is a pet and the event is acquiring the pet.

In still a further aspect of the picture frame, the switching includes start switching for inputting the current date and event switching for inputting the event date, wherein the chronometer includes time addition circuitry for adding the time interval between the current date and the event date to provide a start time for counting forward from the event date.

In still a further aspect of the picture frame, actuator buttons are provided which are integral with the frame and are connected to the switching for starting the chronometer and activating the elapsed time display.

### BRIEF DESCRIPTION OF THE DRAWINGS

Various other features and attendant advantages of the present invention will be more fully appreciated as the same becomes better understood when considered in conjunction with the accompanying drawings, in which like reference characters designate the same or similar parts throughout the several views, and wherein:

FIG. 1 is an embodiment of the picture frame wherein the image displayed is an infant;

FIG. 2 is an embodiment of the picture frame wherein the image displayed includes a pet;

FIG. 3 is an embodiment of the picture frame when the image displayed is a couple;

FIG. 4 is a schematic illustration of a chronometer and crystal which drives a display and is controlled by an array of actuator switches, and

FIG. 5 is a block diagram of a time circuit utilizing the chronometer of FIG. 4.

### DETAILED DESCRIPTION

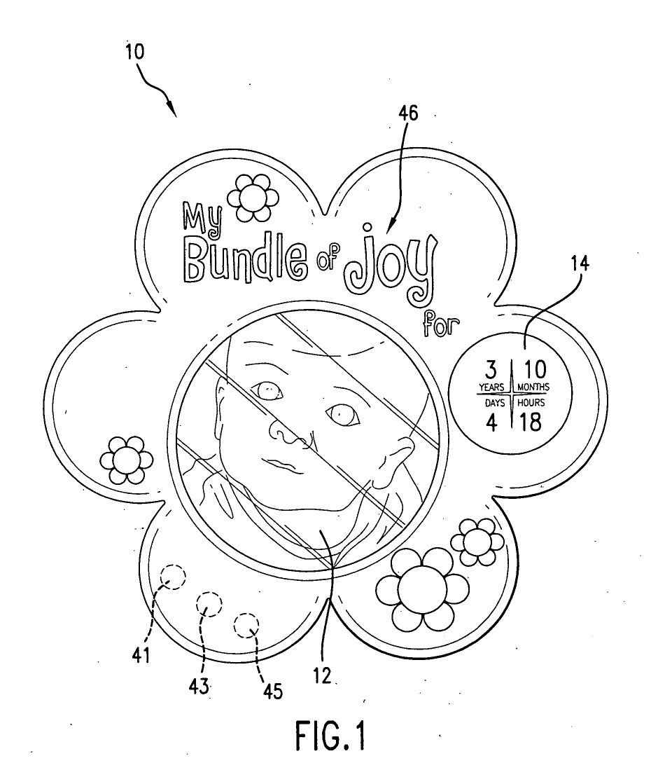

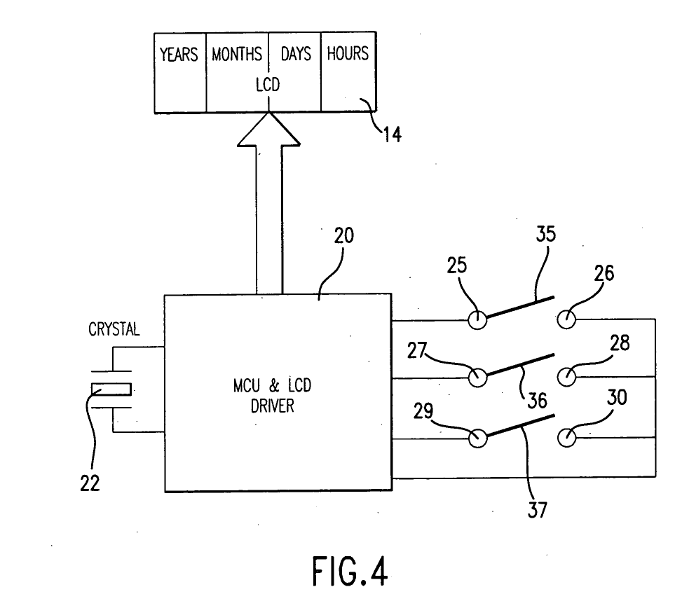

Referring now to FIGS. 1, 2 and 3 there are shown picture frames 10, 12 and 14 each having a different configuration and displaying images 12, 12′ and 12″, respectively, of a different subject. A time display 14 is integral with each of the frames 10, 10′ and 10″, the time display relating to the subject matter of the images. The content of the time display is in years, months, days and hours and is controlled by a chronometer 20 (FIG. 4) to display a lapsed time from occurrence of an event which is the subject of the image 12, 12′ or 12″ mounted in the frame 10, 10′ and 10″.

The chronometer 20 is electrically connected to drive the elapsed time display 14 which functions in a manner similar to a stop watch, but generally only needs to start and continues for years. The chronometer 20 receives a time signal from a crystal 22 which is energized by a long lived battery and is started by closing terminals 25-26, 27-28 and 29-30 connected to the chronometer and operated by actuators 35, 36 and 37, respectively. The actuators 35, 36 and 37 are disposed on the selected frame 10-10″ and are accessed preferably by buttons 41, 43 and 45, as shown in dotted lines on the frames. The buttons 41, 43 and 45 are preferably in the back of the frames 10′-10″ and are preferably not readily accessible after they have been pressed. In a preferred embodiment, the buttons are perhaps initially visible and thereafter are covered by a structure such as a sliding cover (not shown), which must be affirmatively moved from the buttons in order for the buttons to be manually manipulated. Accordingly, the elapsed time count remains relatively secure from inadvertent or intentional manipulation.

The elapsed time display 14 has four time nodes wherein years are displayed from the year 1900 and after, starting with 0 years. Months are displayed with the numerals 1-12; days are displayed with the numerals 01-31, and hours are displayed with the numerals 00-23.

In operation, the current date and time are set by pressing and releasing the button 43. Button 45 is then immediately pressed and the year in four digits begins to flash on the display 14. The year, which is displayed on the elapsed time display, 14 can be moved down by pressing the button 41. The button 41 is pressed repeatedly for slow movement of the year and continuously held down for fast movement of the year. To move the year up, the key 43 is pressed repeatedly for slow movement of the year up or held down for fast movement for the year up.

When the correct year is reached, the button 45 is pressed to move to display of the month which will flash on the display 14 in two digits. In order to set the month, the button 41 is pressed down for slow movement of the month and held down for fast movement of the month, while the button 43 is pressed repeatedly for slow movement of the month and held down for fast movement for the month.

To set the day, 1-31 and hour 1-24, again press the key 45 to move the day and press button 41 for moving the day down and the button 43 for moving the day up. When the day is finally determined, press the button 45 so that the current year, month and day is present in the chronometer 20. Finally, to set the hour, press button 41 down to decrease the hour and press button 43 to increase the hour, pressing these buttons repeatedly for slow movement of the hour and continuously to cause fast movement of the hour. When finished, press the button 45 and the chronometer 20 will hold the current date, and time in years, months, days and minutes.

In order to set event time, the button 41 is pressed and released. Immediately the button 45 is pressed causing the year in four digits to flash. The button 41 is pressed to move the year down by pressing repeatedly for slow movement or continuously for fast movement. In order to move the month, press the button 45 to the month, the month will flash in two digits. Again, press the button 41 for decreasing the month and press the key 43 for increasing the month by pressing these keys either repeatedly for slow movement or continuously for fast movement.

To enter the day of the event using the numbers 1-31 and hour 1-24, again press the button 41 down repeatedly to slowly determine the day or continuously quickly determine the day. If the day must be increased, hold the button 43 down repeatedly for slowly determining the day or continuously to rapidly determine the day. Finally, determine the hour by holding the button 41 down repeatedly to decrease the hour at a slow rate or continuously to decrease the hour at a fast rate. Then hold button 43 down repeatedly to increase the hour slowly and continuously to increase the hour rapidly.

When the date and time of the event has been inserted into the chronometer 20 as described, the button 45 is pressed to hold the event, date and time and the elapsed time screen reads how long it has been in years, months, days and hours from the memorable occasion which is the subject of the image 12-12″. The energized crystal 22 then continuously inputs additional time into the chronometer 20, which additional time is added to the previously elapsed time and is continuously displayed by the elapsed time display 14. For example, the elapsed time from the baby's birth is the subject of the image in FIG. 1 is 0 years, 8 months, 22 days and 5 hours.

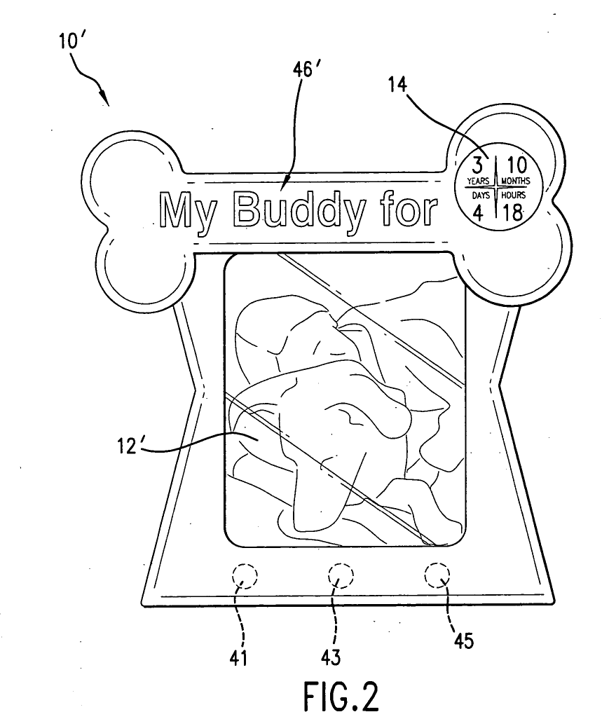

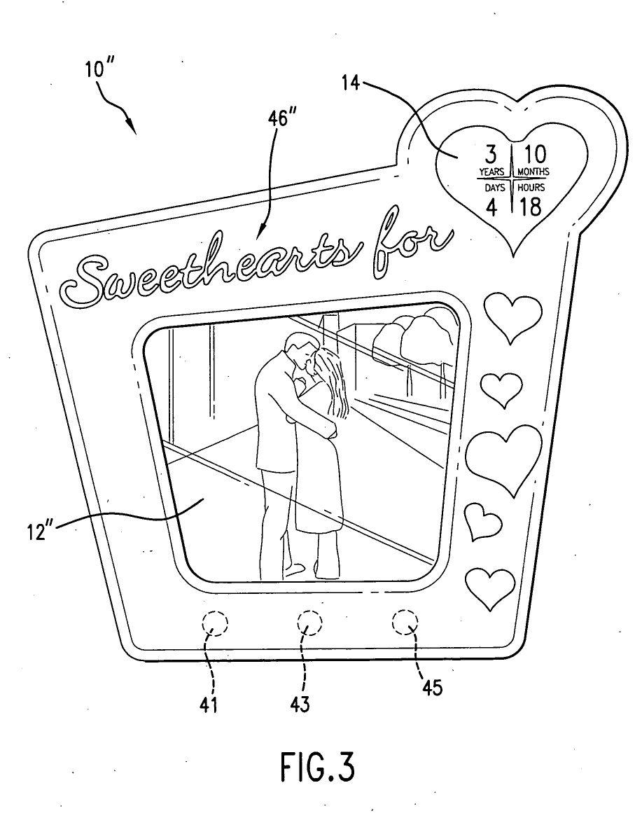

Additionally, the images in the spaces 12-12″ of FIGS. 1-3 have indicia 46, 46′ and 46″ that relates the images to elapsed time. For example, the indicia 46 for an infant image 12 states “My Bundle of Joy for;” the pet image 12′ of FIG. 2 has the indicia 46′ “My Buddy for,” and the couple image 12″ of FIG. 3 has the indicia 46″ of “Sweethearts for.”

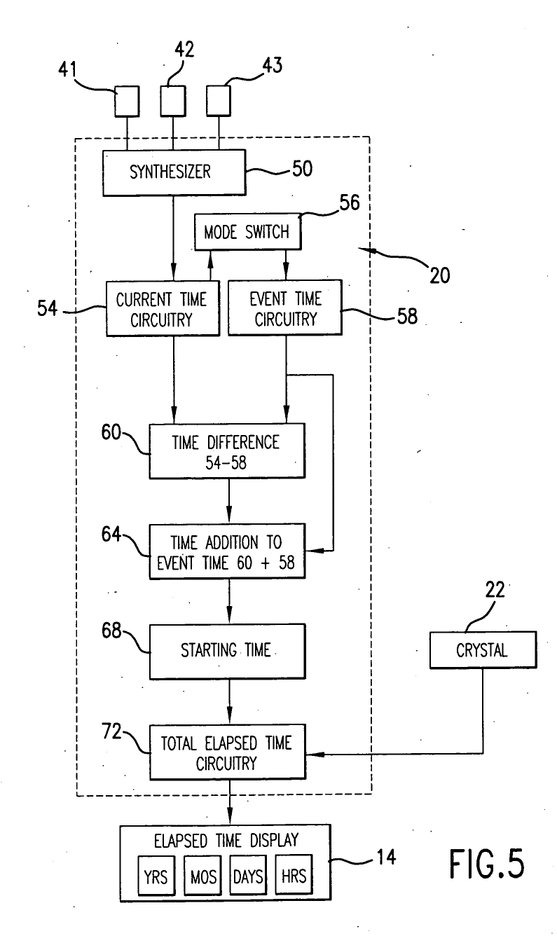

Referring now to FIG. 5 where a block diagram illustrating the circuit of FIG. 4 in more detail is shown, it is seen that the buttons 41, 42 and 43 which are pressed manually but connected to a synthesizer 50 that has a direct input to current time circuitry so as to input the present date and hour 50 into current time circuitry 54 in the chronometer 20. The current time input 54 records the year, month, day and hour in accordance with the previously described protocol. Once the current time is recorded in the current time circuitry 54 a mode switch 56 switches the input of the buttons 41, 42 and 43 to event time circuitry which records the year, month, day and hour of the event which is in most situations a time before the current time.

Time difference circuitry 60 receives inputs from the current times circuitry 54 in the event time circuitry 58 and subtracts the event time input from the current time input to store the time difference between the current time and the event time. Time addition circuitry 64 then adds the time difference from the time difference circuitry 60 to the event time from the event time circuitry time 58 to create the starting time. For example, the starting time 68 may be 0 years, 2 months, 5 days and 11 hours. Time from the crystal 22 is then added to the start time in total elapsed time circuitry 72 to provide an output indicative of total elapsed time to the elapsed time display 14 in years, months, days and hours. Consequently, if the current date and time is Apr. 10, 2005 at 1600 hours and the event occurred on May 31, 2003 at 1800 hours, the currently displayed on the elapsed time display 14 would have been 1 year, 10 months, 10 days and 2 hours. As of Apr. 20, 2005 at 1700 hours, the time displayed would be 1 year, 10 months, 20 days and 1 hour because the crystal 22 has inputted time pulses that the chronometer 20 converts to hours and accumulates to years, months, days and hours for the elapsed time display 14.

A chronometer 20, crystal 22 and input circuitry comprising the buttons 41, 42 and 43 is available from the MSSA TECH, of Shang-hi, China, ADDRESS: ROOM A-20, 5/F, PORFCIENT INDUSTRIAL CENTRE, KOWLOON BAY, KOWLOON, HONG KONG. model number QA-040040FP.

From the foregoing description, one skilled in the art can easily ascertain the essential characteristics of this invention, and without departing form the spirit and scope thereof, can make various changes and modifications of the invention to adapt it to various usages and conditions.

We claim:

1. A picture frame comprising:
a frame enclosing an area for displaying a picture of a subject, the subject being related to the time an event occurred;
a chronometer integral with the frame for counting the time forward from the occurrence of the event;
switching disposed on the frame and connected to the chronometer for activating the chronometer to count time from the occurrence of the event, and
an elapsed time display on the frame and connected to the chronometer for displaying accumulated time since the occurrence of the event in years, months and days.

2. The picture frame of claim 1 wherein the display further includes hours.

3. The display of claim 2 wherein the display is circular and divided by four radial lines into four segments that display years, months, days and hours.

4. The picture frame of claim 3 wherein the frame includes indicia proximate the area for displaying the picture relating to the elapsed time display.

5. The picture frame of claim 4 wherein the subject is an infant and the event is the infant's birth.

6. The picture frame of claim 4 wherein the subject is a person and the event is a memorable occasion relating to that person.

7. The picture frame of claim 1 wherein the switching includes start switching for inputting the current date and event switching for inputting the event date, and wherein the chronometer includes time addition circuitry for adding the time interval between the current date and the event date to provide a start time for counting forward from the event date.

8. The picture frame of claim 7 wherein the activator buttons are integral with the frame and are connected to the switching for starting the chronometer and activating the elapsed time display.

9. A picture frame, comprising:
a frame enclosing an area for displaying a picture of a subject, the subject being related to the occurrence of an event;
a chronometer integral with the frame;
start switching connected to the chronometer for inputting a current time into the chronometer,
event switching connected to the chronometer for inputting the event time into the chronometer;
activators connected to the start switching and to the event switching, the activation being integral with the frame for operating the switching and initiating the time count,
a time subtraction circuit within the chronometer for determining the time difference between the current time and the event time;
a time addition circuit for adding the time difference to the event time to determine a starting time;
total elapsed time circuitry for adding running time continuously to the starting time, and;
a time display integral with the frame and connected to the chronometer for displaying the years, months, days and hours elapsed since occurrence of the event.

10. The picture frame of claim 9 wherein the frame includes separate indicia relating the picture to the time display.

11. The picture frame of claim 9 wherein the activators on the frame have surfaces for digital activation.

12. The picture frame of claim 11 wherein the picture is covered with a transparent display screen, the display screen being connected to the chronometer to display an image of the elapsed time since occurrence of the event.
